(19) United States
(12) Patent Application Publication
(10) Pub. No.: US 2025/0242503 A1
(43) Pub. Date: Jul. 31, 2025

(54) SYSTEM AND METHOD FOR MOUNTING VEHICLE PARTS

(71) Applicants: Hyundai Motor Company, Seoul (KR); Kia Corporation, Seoul (KR); CMES Inc., Daejeon (KR)

(72) Inventors: Beom-Chul KIM, Hwaseong-si (KR); Myoung-Jin SEO, Seoul (KR); Min-Seong CHU, Seoul (KR); Sung-Ho LEE, Seoul (KR); Sang-Yong PARK, Goyang-Si (KR)

(21) Appl. No.: 18/943,679

(22) Filed: Nov. 11, 2024

(30) Foreign Application Priority Data
Jan. 25, 2024 (KR) 10-2024-0011740

(51) Int. Cl. B25J 15/06; B25J 9/16

(52) U.S. Cl. CPC B25J 15/0683; B25J 9/1633; B25J 9/1697

(57) ABSTRACT

A system for mounting vehicle parts, includes an articulated mounting robot, a gripper coupled to an end portion of the mounting robot and configured to grip vehicle parts by a gripping portion, and a controller operatively connected to the gripper and the mounting robot and configured to control an operation of the gripper to grip the vehicle parts and control movement of the mounting robot to a mounting portion of the vehicle body where the vehicle parts are to be mounted, allowing the vehicle parts to be efficiently provided on the vehicle body while reducing the number of people and time for part installation work.

### CROSS-REFERENCE TO RELATED APPLICATION

The present application claims priority to Korean Patent Application No. 10-2024-0011740, filed on Jan. 25, 2024, the entire contents of which is incorporated herein for all purposes by this reference.

### BACKGROUND OF PRESENT DISCLOSURE

### Field of Present Disclosure

The present disclosure relates to a system and method for efficiently mounting parts, which are used in a vehicle manufacturing process, on a vehicle body.

### Description of Related Art

In a vehicle manufacturing process, parts for assembly need to be assembled in the right place according to a corresponding vehicle type.

For example, there are plugs for closing holes formed in a manufactured vehicle body, and a process of attaching the plugs meeting specifications to a plurality of holes in the vehicle body and closing the plurality of holes by workers is required.

To install these parts at local positions on the vehicle body, excessive work such as looking up or bending at the waist of the workers is inevitable, and thus many musculoskeletal diseases occurs in workers, and it takes a lot of time and number of people to install the vehicle parts.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system and method for mounting vehicle parts, which allows the vehicle parts to be efficiently mounted on a vehicle body while reducing the number of people and time for parts mounting work.

Other objects and advantages of the present disclosure may be understood by the following description and become apparent with reference to the exemplary embodiments of the present disclosure. Also, it is obvious to those skilled in the art to which the present disclosure pertains that the objects and advantages of the present disclosure may be realized by the means as claimed and combinations thereof.

In accordance with an exemplary embodiment of the present disclosure, there is provided a system for mounting vehicle parts, which includes an articulated mounting robot, a gripper coupled to an end portion of the mounting robot and configured to grip vehicle parts by a gripping portion, and a controller operatively connected to the gripper and the mounting robot and configured to control an operation of the gripper to grip the vehicle parts and control movement of the mounting robot to a mounting portion of the vehicle body where the vehicle parts are to be mounted.

Furthermore, the controller may be configured for controlling the gripper to grip the vehicle parts suitable for a vehicle type through input vehicle data.

Furthermore, the system may further include a scanning device coupled to the mounting robot and configured to scan the mounting portion.

Furthermore, the controller is configured to receive a scanned image by the scanning device to determine whether the mounting portion is defective, and in response that the mounting portion is defective, the controller may be configured to generate a new work path for mounting the vehicle parts to the mounting portion.

Furthermore, the controller may match the scanned image by the scanning device with a vehicle body image for the mounting portion input in advance.

Furthermore, the controller may be configured to generate a robot path for moving the mounting robot to the matched mounting portion to control movement of the mounting robot.

Furthermore, the controller may be configured to generate a robot path so that the gripper may approach the mounting portion in a normal direction of a surface of the vehicle body and control the gripper to mount the parts on the mounting portion.

Meanwhile, the system may further include a torque sensor coupled to the gripper and configured for measuring a torque value when the parts are mounted by the gripper.

Furthermore, the controller may analyze the torque value received from the torque sensor to determine a mounting state of the portions.

Furthermore, the gripper may include a cylinder, a cylinder rod configured to be moved forward by the cylinder, a gripping arm coupled to the cylinder rod, and the gripping portion coupled to an end portion of the gripping arm.

Furthermore, the cylinder, the cylinder rod, the gripping arm, and the gripping portion may be formed in the plural; and the plurality of cylinders may be disposed at the same distance from a center portion of a plate.

Furthermore, the gripper may be a multi-gripper configured for gripping a plurality of portions.

Furthermore, the gripping arm may extend in an inclined direction with respect to a longitudinal direction of the cylinder rod, and the gripping arm may be rotated by the cylinder rod so that an end portion of the gripping arm may be movable to a position corresponding to the center portion of the plate.

Furthermore, the system may further include a guider provided at the center portion of the plate and configured to move forward to support a lower portion of the end portion of the gripping arm.

Meanwhile, the gripping portion may be a suction pad with a hole formed in a pad made of flexible material, and air may be drawn through a suction passage fluidically-communicating with the hole.

In accordance with another exemplary embodiment of the present disclosure, there is provided a method of mounting vehicle parts, which includes controlling, by the controller of the system for mounting vehicle parts, the gripper to grip parts matching a vehicle type of input vehicle data; controlling movement of the mounting robot to the mounting portion; scanning the mounting portion by the scanning device; matching a scanned image by the scanning device with a pre-input vehicle body image of the mounting portion to generate a robot path for controlling movement of the mounting robot to the matched mounting portion; and controlling the gripper moved to the mounting portion by the robot path and mounting the parts on the mounting portion.

Furthermore, the method may further include determining a mounting state of the parts by analyzing a torque value received in the mounting of the parts on the mounting portion through a torque sensor coupled to the gripper.

Furthermore, the gripper of the system for mounting the vehicle parts may include a plurality of cylinders, a plurality of cylinder rods configured to be moved forward by the cylinders, a plurality of gripping arms coupled to the cylinder rods and extending in an inclined direction with respect to a longitudinal direction of the cylinder rod, and a plurality of gripping portions coupled to end portions of the gripping arms; and the controlling of the gripper may include controlling the cylinder rod to move forward, controlling rotation of the cylinder rod to move a position of an end portion of the gripping arm, and controlling the gripping portion to grip the portions.

Furthermore, the gripper may further include a guider, and the method may further include, after the moving of the position of the end portion of the gripping arm, controlling the guider to move forward to support the lower portion of the end portion of the gripping arm.

Furthermore, in the generating of the robot path, a robot path may be generated so that the gripper may approach the mounting portion in a normal direction of a surface of the vehicle body.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram illustrating a portion of a system for mounting vehicle parts of the present disclosure.

FIG. 2 is a diagram illustrating a method of mounting vehicle parts of the present disclosure.

FIG. 3 is a schematic diagram illustrating a multi-gripper of the system for mounting vehicle parts of the present disclosure.

FIG. 4, FIG. 5 and FIG. 6 are diagrams illustrating an operating state of the multi-gripper of the system for mounting vehicle parts of the present disclosure.

FIG. 7 is a diagram illustrating a torque sensor of the system for mounting vehicle parts of the present disclosure.

FIG. 8 and FIG. 9 are diagrams illustrating a state of a mounting hole before the vehicle parts are mounted according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

To fully understand the present disclosure and operational advantages of the present disclosure and objects attained by practicing the present disclosure, reference should be made to the accompanying drawings that illustrate exemplary embodiments of the present disclosure and to the description in the accompanying drawings.

In describing exemplary embodiments of the present disclosure, a description known technologies or repeated descriptions may be reduced or omitted to avoid unnecessarily obscuring the gist of the present disclosure.

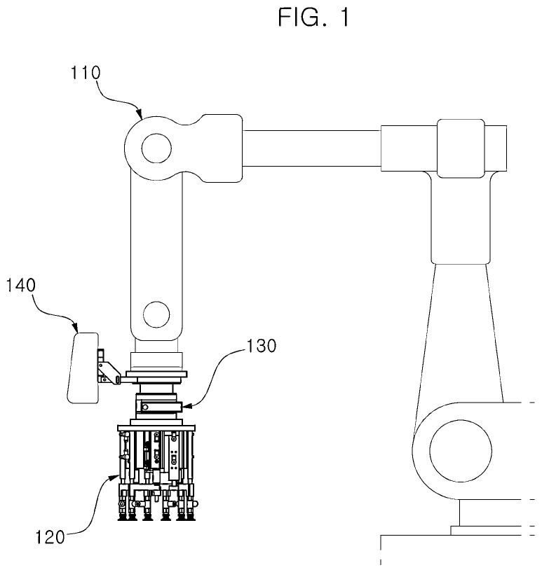

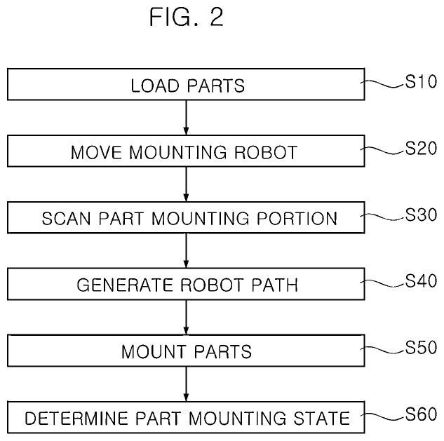

FIG. 1 is a schematic diagram illustrating a portion of a system for mounting vehicle parts of the present disclosure, and FIG. 2 is a diagram illustrating a method of mounting vehicle parts of the present disclosure.

Hereinafter, a system and method for mounting vehicle parts according to an exemplary embodiment of the present disclosure will be described with reference to FIG. 1 and FIG. 2.

Parts mounted on vehicles, for example, plugs for closing holes formed in a vehicle body, with a variety of specifications are applied. According to an exemplary embodiment of the present disclosure, to enable a multi-specification response for mounting these various plugs, by utilizing a mounting robot 110, a gripper 120, a torque sensor 130 (force and torque (F/T) sensor), a scanning device 140 (three-dimensional (3D) vision), and a controller (simulator), an actual body surface is scanned by loading plugs supplied from a random bin picking system loaded with parts, a changed position of the vehicle body is identified to be converted and matched with the existing drawing data, and a robot path for perform a plug mounting task is generated (taught).

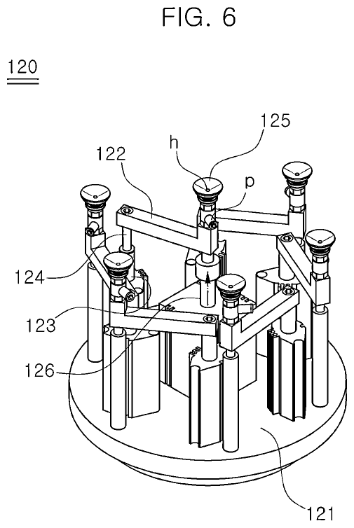

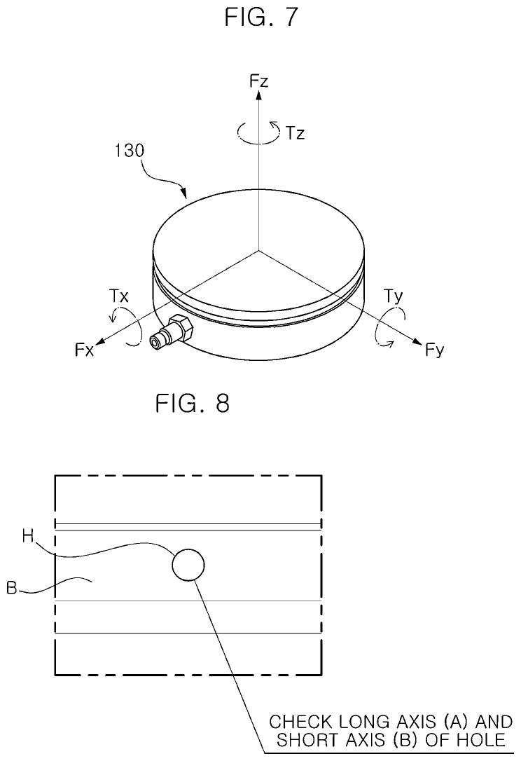

In an exemplary embodiment of the present disclosure, the torque sensor 130 may measure the forces Fx, Fy, Fz in x-y-z axes and torques Tx, Ty, Tz in x-y-z axes, as shown in FIG. 7.

To describe the method of mounting vehicle parts of the present disclosure with reference to FIG. 2, a vehicle type is first recognized through vehicle data input to the controller, and the gripper 120 loads a plug used for the corresponding vehicle model (S10).

As shown in the drawing, the gripper 120 may be a multi-gripper configured for individually gripping a plurality of parts and moving the parts simultaneously.

In a state in which the parts are loaded, the mounting robot 110 is controlled to move from a part loading position to a part mounting portion in which the parts is to be mounted (S20). To the present end, the mounting robot 110 is a robot device configured for performing a multi-axis operation such as a 7-axis operation, and the multi-gripper 120, the torque sensor 130, and the scanning device 140 may be coupled to the mounting robot 110.

Accordingly, a plug mounting portion of the vehicle body is scanned by the scanning device 140 coupled to the mounting robot 110 (S30). A scanning position specifies a portion including a mounting hole and a feature point.

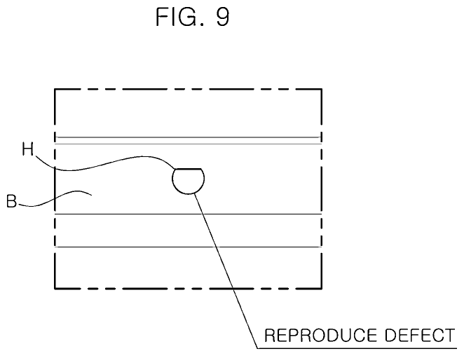

Accordingly, the controller is configured to perform a task of matching a scanned image with the center portion of the mounting hole of a vehicle body drawing image registered in advance in the controller, inspects a state of the mounting hole, and configures a work pass sequence when plug installation is not possible. FIG. 8 shows a normal state of a mounting hole H of a vehicle body B, and as shown in FIG. 9, a defective state of the mounting hole is inspected.

That is, the scanned image by the scanning device 140 is preprocessed, and the preprocessed scanned image is overlapped with the vehicle body drawing image for the part mounting portion to match the part mounting portion including the mounting hole with the vehicle body drawing image. A correction value according to the matching result is determined to match the centers of the two images, and a robot path, which will be described below, is generated according to the matched centers.

A robot path is generated so that the multi-gripper 120 enters the matched mounting position horizontally (in a normal direction) with respect to a vehicle body surface (S40), and the parts are provided (S50).

Before the parts are provided, a corresponding plug is provided for installation by operation of the multi gripper 120, and a value of the torque sensor 130 is reset.

The control device receives and analyzes data fed back from the torque sensor 130 during a part's installation to determine whether the part installation state is correct or not. (S60).

Through the above method, it is possible to automatically install various plugs (a material, a shape, and the like) according to various vehicle types and specifications.

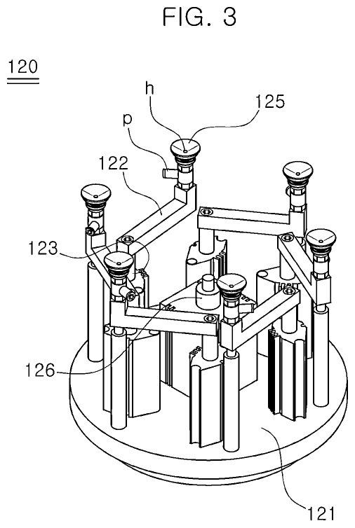

Next, FIG. 3 is a schematic diagram illustrating a multi-gripper of the system for mounting vehicle parts of the present disclosure.

The multi gripper 120 is coupled to an end portion of the mounting robot 110 and is used to grip a plurality of parts by a plurality of gripping portions 125 and then mount the parts on the vehicle body.

In an exemplary embodiment of the present disclosure, the gripping portion 125 includes a suction pad to adsorb and grip a plug and may be configured to grip other vehicle parts as a different type of gripping portion.

The suction pad includes a hole h in the center portion of the suction pad made of a flexible material such as rubber or silicone and is configured to grip the parts by drawing out the air through the hole h. Furthermore, for drawing out the air, a suction passage port p and a suction passage s may be coupled to a gripping arm 122 and a suction pump is connected to the suction passage.

The gripping portion 125 is provided as a plurality of gripping portions to grip a plurality of parts and parts with different specifications.

To move the gripping portion 125 forward and rotate the gripping portion 125, a plurality of cylinders 123 are mounted on one surface of the plate 121. Due to operation characteristics, the plurality of cylinders 123 may be disposed at the same distance from the center portion of the plate 121 and disposed at equal intervals from each other in a circumferential direction of the plate 121.

A cylinder rod 124, which moves forwards and backwards by the cylinder 123, is coupled to the cylinder 123, and the gripping arm 122 is coupled to each cylinder rod 124.

The gripping arm 122 is a component extending in an inclined direction with respect to a longitudinal direction of the cylinder rod 124, and the gripping arm 122 may be more preferable to extend in a vertical direction.

Furthermore, the gripping portion 125 is coupled to and formed at an end portion of the gripping arm 122.

As shown in the drawings, a plurality of supports may be formed in a cylinder manner to support the end portion of the gripping arm 122 in a state before the gripping arm 122 operates. A guider 126 is formed in the center portion of the plate 121 to support the end portion of the gripping arm 122 when the end portion of the gripping arm 122 is moved to a position corresponding to the center portion of the plate 121 by a method which will be described below.

A hydraulic or pneumatic pressure may be applied to maintaining the above-described state or operation of the cylinder 123, the support, and the guider 126.

Furthermore, a part for forming a vacuum after the suction pad comes into contact with the parts may also be provided.

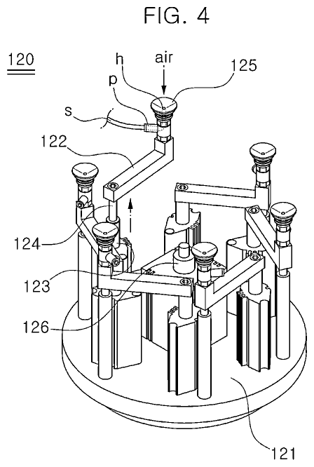

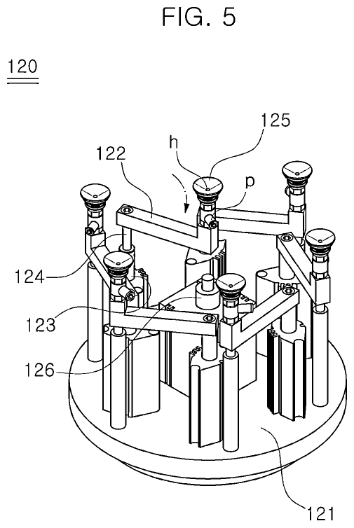

As shown in FIG. 4, FIG. 5 and FIG. 6, the multi gripper 120 operates sequentially to grip the parts or mount the parts on the vehicle body.

First, as shown in FIG. 4, the cylinder rod 124 moves forward, and thus the gripping arm 122 and the gripping portion 125 move forward, and sequentially, as shown in FIG. 5, the cylinder 123 is rotated to position the end portion of the gripping arm 122 at the center portion of the plate 121.

Accordingly, as shown in FIG. 6, the guider 126 moves by an actuator forward to support a lower portion of the end portion of the gripping arm 122 to grip or release the vehicle parts.

Next, FIG. 7 shows the torque sensor 130 coupled to rear surfaces of the multi-gripper 120 and the plate 121, and a value of the torque sensor 130 is reset by the multi-gripper 120 at a stage before part installation.

Furthermore, with the part installation, the controller is configured to receive and analyzes data fed back from the torque sensor 130 to determine a part installation state (OK/NG).

As described above, according to an exemplary embodiment of the present disclosure, multiple and vehicle parts with various specifications are automatically held and provided, and thus workers do not have to install each part in a bad posture in a narrow work space so that musculoskeletal disorders of the workers are prevented and avoidance work is eliminated and thus it is more advantageous in terms of work efficiency and safety.

In accordance with a system and method for mounting vehicle parts according to an exemplary embodiment of the present disclosure, workers do not have to install each portion in a bad posture in a narrow work space so that musculoskeletal disorders of the workers may be prevented and avoidance work may be eliminated and thus it is more advantageous in terms of work efficiency and safety.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for mounting vehicle parts, the system comprising:
a mounting robot;
a gripper coupled to an end portion of the mounting robot and including a gripping portion configured to grip the vehicle parts; and
a controller operatively connected to the gripper and the mounting robot and configured to control an operation of the gripper to grip the vehicle parts and control movement of the mounting robot to a mounting portion of the vehicle body where the vehicle parts are to be mounted.

2. The system of claim 1, wherein the controller is further configured to control the gripper to grip the vehicle parts suitable for a vehicle type based on input vehicle data.

3. The system of claim 1, further including:
a scanning device coupled to the mounting robot and configured to scan the mounting portion.

4. The system of claim 3, wherein the controller operatively connected to the scanning device is further configured to receive a scanned image from the scanning device to determine whether the mounting portion is defective, and in response that the mounting portion is defective, the controller is further configured to generate a new work path for mounting the vehicle parts to the mounting portion.

5. The system of claim 3, wherein the controller is further configured to match the scanned image with a vehicle body image for the mounting portion input in advance.

6. The system of claim 5, wherein the controller is further configured to generate a robot path for moving the mounting robot to a matched mounting portion of the vehicle body to control the movement of the mounting robot according to the robot path.

7. The system of claim 6, wherein the controller is further configured to generate the robot path so that the gripper approaches the mounting portion in a normal direction of a surface of the vehicle body and to control the gripper to mount the vehicle parts on the mounting portion.

8. The system of claim 1, further including:
a torque sensor coupled to the gripper and configured for measuring a torque value in response that the vehicle parts are mounted by the gripper.

9. The system of claim 8, wherein the controller operatively connected to the torque sensor is further configured to analyze the torque value received from the torque sensor to determine a mounting state of the vehicle parts.

10. The system of claim 1, wherein the gripper is a multi-gripper configured for gripping a plurality of vehicle parts.

11. The system of claim 1, wherein the gripper includes:
a cylinder;
a cylinder rod configured to be moved forward by the cylinder;
a gripping arm coupled to the cylinder rod; and
the gripping portion coupled to an end portion of the gripping arm.

12. The system of claim 11,
wherein the cylinder, the cylinder rod, the gripping arm, and the gripping portion are formed in the plural, and
wherein the plurality of cylinders are mounted on a plate and disposed at a same distance from a center portion of the plate.

13. The system of claim 12, wherein the gripping arm extends in an inclined direction with respect to a longitudinal direction of the cylinder rod, and the gripping arm is rotated by the cylinder rod so that the end portion of the gripping arm is movable to a position corresponding to the center portion of the plate.

14. The system of claim 13, further including:
a guider provided at the center portion of the plate and configured to move forward to support a lower portion of the end portion of the gripping arm.

15. The system of claim 1, wherein the gripping portion includes a suction pad with a hole formed in the suction pad made of flexible material, and air is drawn through a suction passage fluidically-communicating with the hole.

16. A method of mounting the vehicle parts, the method comprising:
controlling, by the controller of the system for mounting the vehicle parts of claim 3, the gripper to grip the vehicle parts matching a vehicle type of input vehicle data;
controlling, by the controller, the movement of the mounting robot to the mounting portion;
scanning, by the controller, the mounting portion by use of the scanning device;
matching, by the controller, a scanned image by use of the scanning device with a pre-input vehicle body image of the mounting portion to generate a robot path for controlling the movement of the mounting robot to a matched mounting portion according to the robot path; and
controlling, by the controller, the gripper moved to the matched mounting portion by the robot path and mounting the vehicle parts on the matched mounting portion.

17. The method of claim 16, further including:
determining, by the controller, a mounting state of the vehicle parts by analyzing a torque value received in the mounting of the vehicle parts on the mounting portion from a torque sensor coupled to the gripper.

18. The method of claim 16,
wherein the gripper of the system for mounting the vehicle parts includes a plurality of cylinders, a plurality of cylinder rods configured to be moved forward by the cylinders, a plurality of gripping arms coupled to the cylinder rods and extending in an inclined direction with respect to a longitudinal direction of the cylinder rods, and a plurality of gripping portions coupled to end portions of the gripping arms, and
wherein the controlling of the gripper includes:
controlling the cylinder rods to move forward;
controlling rotation of the cylinder rods to move a position of an end portion of the gripping arms; and
controlling the gripping portions to grip the vehicle parts.

19. The method of claim 16,
wherein the gripper further includes a guider, and
wherein the method further includes, after the moving of a position of an end portion of the gripping arm, controlling, by the controller, the guider to move forward to support a lower portion of the end portion of the gripping arm.

20. The method of claim 16, wherein, in the generating of the robot path, the robot path is generated so that the gripper approaches the mounting portion in a normal direction of a surface of the vehicle body.
